(19) United States
(12) Patent Application Publication
(10) Pub. No.: US 2007/0127360 A1
(43) Pub. Date: Jun. 7, 2007

(54) Method of adaptive transmission in an orthogonal frequency division multiplexing system with multiple antennas

(76) Inventors: Hyung-Kyu Song, Gyeonggi-do (KR); Young-Hwan Choi, Gyeonggi-do (KR)

Correspondence Address: CANTOR COLBURN, LLP, 55 GRIFFIN ROAD SOUTH, BLOOMFIELD, CT, 06002, US

(21) Appl. No.: 11/295,254

(22) Filed: Dec. 5, 2005

(51) Int. Cl. H04J 11/00

(52) U.S. Cl. 370/208

(57) ABSTRACT

Disclosed is method of adaptive transmission in an OFDM system with multiple antennas. The adaptive transmission scheme includes an STBC, BLAST, and combined STBC/BLAST. By estimating channel environment, the method selects the proper transmission scheme among the STBC, BLAST, and STBC-BLAST. Therefore, the method has an advantage of each technique, e.g. diversity gain or high transmission rate. By using the method, the reliable and high data-rate communications are achieved.

### BACKGROUND OF THE INVENTION

1. Field of the Invention

The present invention relates to a method of adaptive transmission in an MIMO (multiple input multiple output) OFDM (orthogonal frequency division multiplexing) system and, more particularly, to a method of selecting the MIMO transmission scheme among the STBC (space-time block code), BLAST (bell laboratories layered space-time), and combined STBC/BLAST according to the channel condition. By properly selecting the transmission scheme, the method has an advantage of each technique, e.g. diversity gain or high transmission rate.

2. Description of the Related Art

OFDM is commonly used for high data rate wireless communication due to its inherent error susceptibility in a multipath environment. A combination of MIMO signal processing with OFDM is regarded as a promising solution for enhancing the performance of next generation wireless communication. The MIMO antenna techniques could provide higher spectral efficiency and increase potentially the system capacity.

Generally, MIMO systems are classified into two large groups. First, MIMO diversity transmission technique exists. Particularly, STBC is a representative diversity transmission technique. The STBC obtains gain of transmitting diversity by transmitting the same data for multiple transmitting antennas. Therefore, STBC technique brings the improvement of error performance through the diversity gain. However, MIMO diversity technique has a waste of throughput performance in a high SNR (signal-to-noise ratio) environment by giving up the transmission of more data despite of good link capability. A schematic of this idea is depicted in FIG. 1. The STBC consists of an information source 10, a constellation mapper 12, a ST block code generator 14, a STBC decoder 16, and two ML decision blocks 18 and 20.

On the other side, MIMO multiplexing technique (known also as BLAST) transmitting the different data at multiple transmitting antennas supports the high speed transmission rate without increasing of system bandwidth as shown in FIG. 2. The BLAST consists of VBLAST encoder 22, encoders 24-1 to 24-M, a nulling/interference cancellation block 26, decoders 28-1 to 28-N, and a parallel-to-serial converter 30.

The BLAST can theoretically offer a nearly linear increase in capacity. However, at a low SNR environment, the BLAST suffers from the loss of BER (bit error rate) performance which is due to the imperfect symbol cancellation.

The combined STBC/BLAST can achieve the high-speed and reliable communication. A schematic of this idea is depicted in FIG. 3. The combined STBC/BLAST consists of a VBLAST encoder 32, STBC blocks 34-1 and 34-2, parallel-to-serial blocks 36-1 to 36-4, serial-to-parallel blocks 38-1 and 38-2, and group interference suppression and space-time block decoder 40.

The combined STBC/BLAST obtains the advantages of both STBC and BLAST. However, the scheme has the disadvantage of both STBC and BLAST, too. And since the combined STBC/BLAST uses diversity technique, the transmission efficiency of combined STBC/BLAST is only one half of BLAST.

### SUMMARY OF THE INVENTION

The present invention has been made in an effort to overcome the limitation of above MIMO schemes.

It is an object of the present invention to provide a method of adaptive transmission which guarantees the intelligent communication for various channel environments with some MIMO techniques.

To achieve the object, the present invention uses above MIMO schemes (STBC, BLAST, and combined STBC/BLAST). Among the MIMO schemes, the STBC has a weak point at high SNR, and the BLAST has a weakness at low SNR. And, though the combined STBC/BLAST provides a befitting combination structure, its throughput is only one half of the BLAST.

Therefore, the present invention selects the suitable MIMO transmission scheme according to channel environment. The method selects the STBC scheme to transmit the information data at inferior channel environment, and selects the BLAST scheme at high SNR environment. At the middle SNR environment, this method uses the combined STBC/BLAST for transmission scheme. The channel environment can be obtained by estimating MIMO SNR.

The transmission mode selector in FIG. 3 between STBC, BLAST, and combined STBC/BLAST decides its MIMO transmission mode according to the channel SNR. A basic mode selection probability Pr(T^{l}) is defined as the probability of selecting the l-th mode from the set of available MIMO transmission modes. The transmission mode Tₗ is defined by the following rules;

$${T}_{l} = \{ \begin{matrix}STBC & if γ < {μ}_{1} \\ Combined & if {μ}_{1} \leq γ < {μ}_{2} \\ STBC / BLAST & \\ BLAST & if γ \geq {μ}_{2}\end{matrix}$$

where γ and μ₁ denote the channel quality value and the mode-switching level, respectively.

By properly selecting the MIMO scheme, this scheme satisfies the diversity gain and very high-rate transmission according to the channel condition.

### BRIEF DESCRIPTION OF THE DRAWINGS

Further objects and other advantages of the present invention will become apparent from the following description in conjunction with the attached drawings, in which:

FIG. 1 is a block diagram of a conventional STBC;

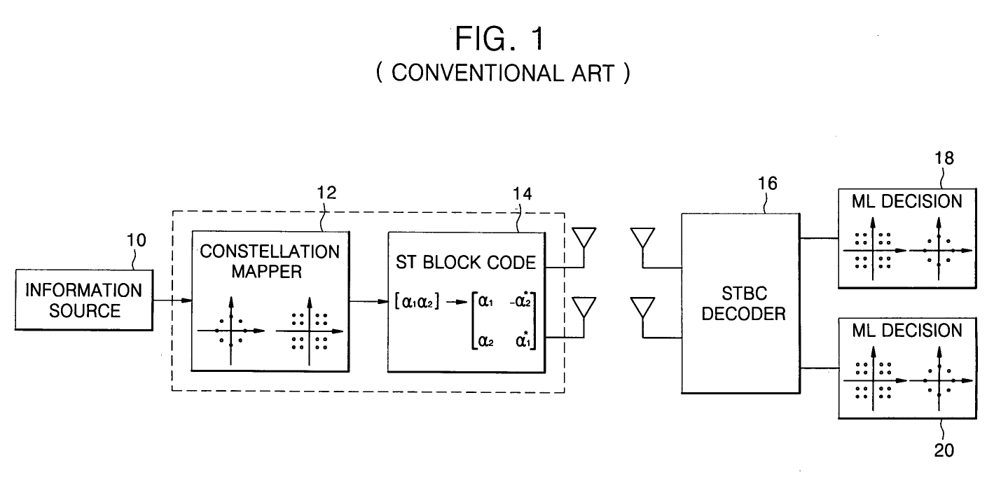

FIG. 2 is a block diagram of a conventional BLAST;

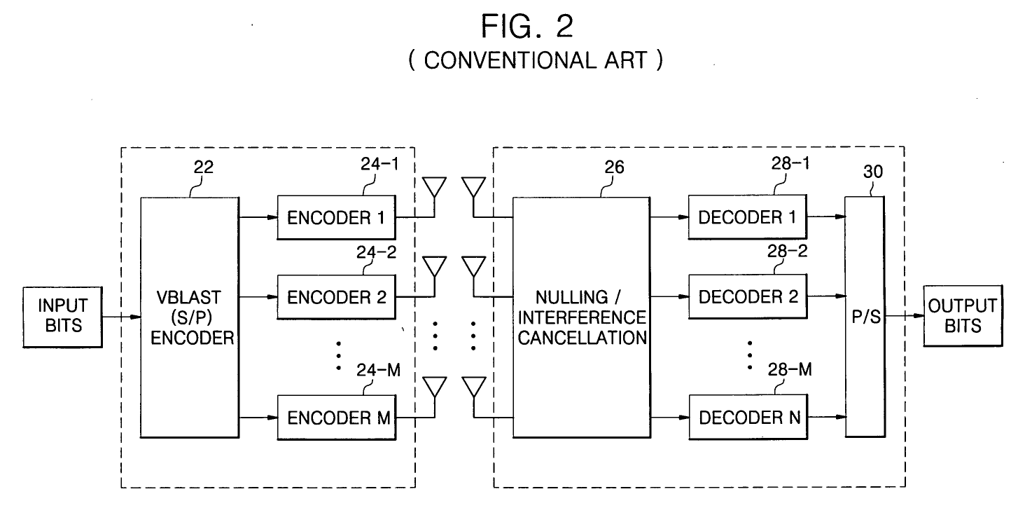

FIG. 3 is a block diagram of a conventional combined STBC/BLAST;

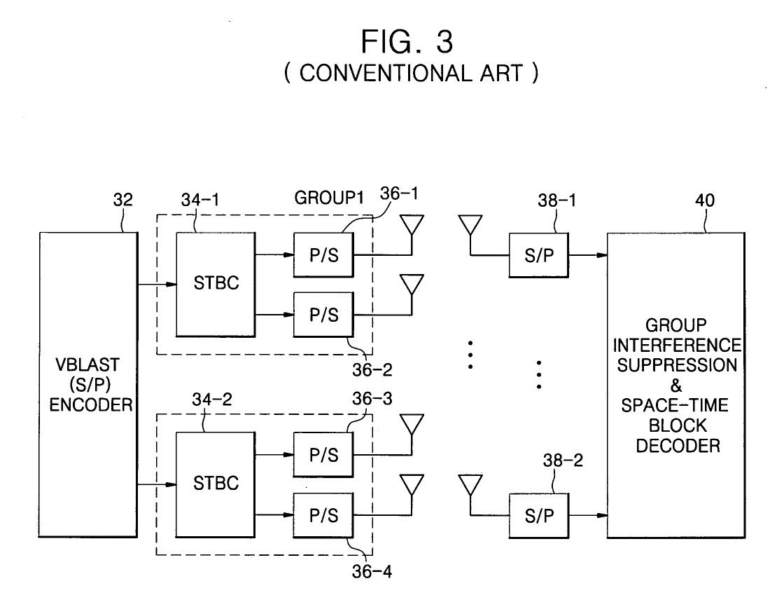

FIG. 4 is a block diagram of a MIMO-OFDM system with the method of adaptive transmission of the present invention;

FIG. 5 is BER performance of method of adaptive transmission in MIMO-OFDM system of the present invention;

FIG. 6 is throughput performance of method of adaptive transmission in MIMO-OFDM system of the present invention; and

FIG. 7 is selection probability of MIMO transmission mode for MIMO-OFDM system with the method of adaptive transmission of the present invention.

### DETAILED DESCRIPTION OF THE PREFERRED EMBODIMENTS

Preferred embodiments of the present invention will now be described in detail with reference to the accompanying drawings.

A MIMO-OFDM system with Nₜ transmitting and Nᵣ receiving antennas is considered. The OFDM data sequence of n-th transmitting antenna is represented as Sₙ=[Sₙ(0)Sₙ(1) . . . Sₙ(K−1)]^{T}, where Sₙ(l), (n=1, 2, . . . , Nₜ) is the complex baseband signal of the l-th subcarrier and K is the length of the OFDM data sequence. Because the symbols are transmitted from Nₜ transmitting antennas in parallel, the Nₜ×K data sequence matrix is x=[X₁ X₂ . . . X_{N}_{ₜ}]^{T}.

A flat fading channel on each subcarrier and independent identically distributed (i.i.d) fading among different subcarriers are assumed in our analysis. The time delay and phase offset of the each antenna are assumed to be known, i.e., tracked accurately. The overall channel H can be represented as Nᵣ×Nₜ complex matrix and the baseband received signal at j-th receiving antenna is

$${R}_{j} ( l ) = {\sum }_{i = 1}^{{N}_{t}} {H}_{ji} {S}_{i} ( l ) + {V}_{j} ( l ) \qquad [ Equation 1 ]$$

where Hⱼᵢ is channel element with i-th transmitting antenna and j-th receiving antenna, and Vⱼ(l) is zero-mean Gaussian noise with variance σᵥ². The overall received signals can be represented as
R=HX+V, [Equation 2]

where R and V are the Nᵣ×K matrices, respectively.

In this method, since the MIMO techniques with 4 transmitting antennas (Nₜ=4) are used, the maximum transmission rate is 4 for the BLAST scheme and the minimum transmission rate is 1 for the STBC. A detailed explanation is as follows.

The STBC obtains gain of transmitting diversity by transmitting the same data for multiple transmitting antennas. The transmission matrix of the STBC for Nₜ=4 can be represented as

$${S}_{S} = [ \begin{matrix}{S}_{1} & - {S}_{2}^{*} & {S}_{3} & - {S}_{4}^{*} \\ {S}_{2} & {S}_{1}^{*} & {S}_{4} & {S}_{3}^{*} \\ {S}_{3} & - {S}_{4}^{*} & {S}_{1} & - {S}_{2}^{*} \\ {S}_{4} & {S}_{3}^{*} & {S}_{2} & {S}_{1}^{*}\end{matrix} ] . \qquad [ Equation 3 ]$$

This STBC technique transmits 4 different data sequences four times using 4 transmitting antennas. Therefore, the transmission rate is 1.

On the other side, the BLAST transmitting the different data at multiple transmitting antennas supports the high speed transmission rate without increasing of system bandwidth. The transmission matrix of the BLAST for Nₜ=4 can be represented as

$${S}_{B} = [ \begin{matrix}{S}_{1} \\ {S}_{2} \\ {S}_{3} \\ {S}_{4}\end{matrix} ] . \qquad [ Equation 4 ]$$

This BLAST scheme transmits 4 different data simultaneously using 4 transmitting antennas. Therefore, the transmission rate is 4.

The combined STBC/BLAST is a form of combining STBC with BLAST. Therefore, the combined STBC/BLAST obtains the advantages of both STBC and BLAST. However, the scheme has the disadvantage of both STBC and BLAST.

And since the combined STBC/BLAST uses diversity technique, the transmission efficiency of combined STBC/BLAST is only one half of BLAST. The combined STBC/BLAST transmission matrix is presented as follows

$${S}_{SB} = [ \begin{matrix}{S}_{1} \\ {S}_{2} \\ {S}_{3} \\ {S}_{4}\end{matrix} \begin{matrix}- {S}_{2}^{*} \\ {S}_{1}^{*} \\ - {S}_{4}^{*} \\ {S}_{3}^{*}\end{matrix} ] \qquad [ Equation 5 ]$$

In this scheme, the 2×1 STBC is executed at two data sequences (S₁˜S₂, S₃˜S₄), respectively. Therefore, the transmission rate is 2.

Among the MIMO schemes, the STBC has a weak point at high SNR, and the BLAST has a weakness at low SNR. And, though the combined STBC/BLAST provides a befitting combination structure, its throughput is only one half of the BLAST.

Therefore, the present invention selects the suitable MIMO transmission scheme according to channel environment. The method selects the STBC scheme to transmit the information data at inferior channel environment, and selects the BLAST scheme at high SNR environment. At the middle SNR environment, this method uses the combined STBC/BLAST for transmission scheme. The channel environment can be obtained by estimating MIMO SNR.

The instantaneous channel SNR is measured by the receiver and the transmission mode selector determine the mode used in the next transmission. The information of the transmission mode is transmitted into the transmitter, using the feedback channel.

To evaluate the channel condition, the estimated SNR at k-th subcarrier from i-th transmitting antenna to j-th receiving antenna, which specify the power ratio of received pure signal and that of noise is defined in the form of

$$\begin{matrix}{SNR}_{ji}^{k} [ dB ] = 10 {log}_{10} \frac{\vert {H}_{ji} {( k )}^{2} \vert □ {{S}_{i} ( k )}^{2}}{{ɛ}_{j}^{2}} \\ Where & [ Equation 6 ] \\ {ɛ}_{j}^{2} = \frac{1}{K} {\sum }_{k = 0}^{K - 1} {( {R}_{j} ( k ) - {\sum }_{t}^{{N}_{t}} {H}_{ji} ( k ) {S}_{i} ( k ) )}^{2} . & [ Equation 7 ]\end{matrix}$$

In this paper, since the adaptive transmission techniques use multiple antennas, the average SNR value which is estimated and averaged at all receiving antennas is required. That is,

$${SNR}_{i} = \frac{1}{K} {\sum }_{k = 0}^{K} {SNR}^{k} . \qquad [ Equation 9 ]$$

where SNRⱼᵢ^{k} is the estimated SNR value in the j-th receiving antenna at the k-th subcarrier. For the method of adaptive transmission, the overall average SNR which is averaged all subcarriers is considered, as follows

$${SNR}_{i}^{k} = \frac{1}{{N}_{r}} {\sum }_{j = 1}^{{N}_{r}} {SNR}_{ji}^{k} \qquad [ Equation 8 ]$$

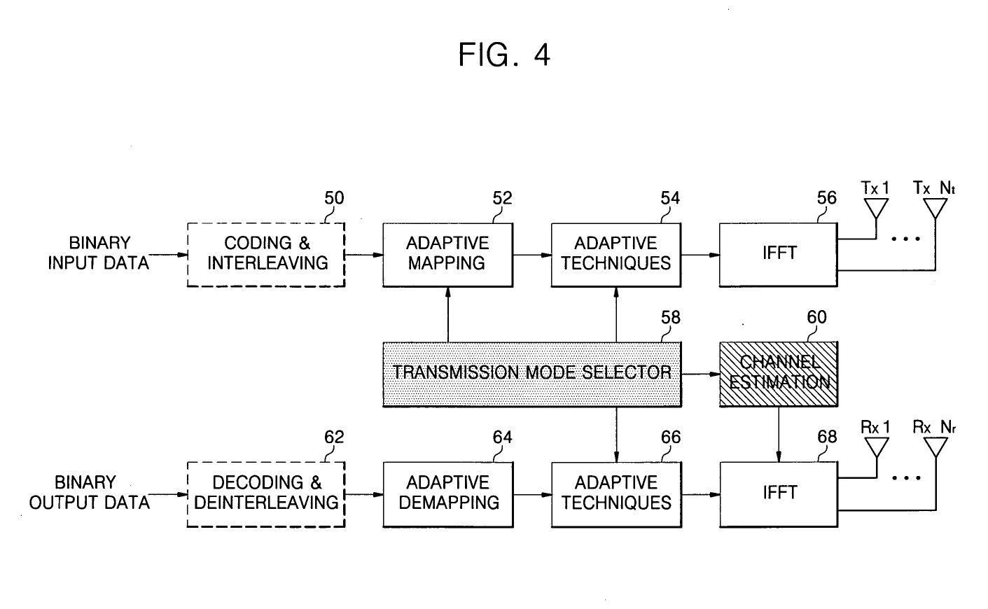

The block diagram of investigate MIMO-OFDM system employing the adaptive transmission techniques is represented in FIG. 4. The MIMO-OFDM system consists of a coding and interleaving block 50, adaptive mapping blocks 52 and 64, adaptive techniques 54 and 66, IFET blocks 52 and 68, a decoding and deinterleaving block 62, transmission mode selector 58, and a channel estimation block 60. The part shown in dotted line is optional in this figure. And the ‘Adaptive Techniques’ block represents the method of adaptive transmission. First, binary input data pass through process of encoding, interleaving and mapping order. Next, transmission mode selector decides its transmitting mode according to the channel SNR and then IFFT process is performed. The information about the selection of transmission mode is delivered into the transmitter, using the system's control channel. This side-information is named mode-selecting feedback information. The different transmission modes are used according to the available mode-selecting feedback information.

In the BLAST, the number of the receiving antennas is equal to or larger than that of the transmitting antennas. For this reason, the number of transmitting and receiving antennas is the same in the method of adaptive transmission scheme. In this case, the transmission mode selector in FIG. 4 between STBC, BLAST, and combined STBC/BLAST decides its MIMO transmission mode according to the channel SNR in Equation 9. A basic mode selection probability Pr(Tₗ) is defined as the probability of selecting the l-th mode from the set of available MIMO transmission modes. The transmission mode Tₗ is defined by the following rules

$${T}_{l} = \{ \begin{matrix}STBC & if γ < {μ}_{1} \\ Combined & if {μ}_{1} \leq γ < {μ}_{2} \\ STBC / BLAST & \\ BLAST & if γ \geq {μ}_{2}\end{matrix} \qquad [ Equation 10 ]$$

where γ and μ₁ denote the channel quality value and the mode-switching level, respectively. Generally, the mode-switching level μ₁ is determined such that the throughput is maximized, while satisfying the average target bit error ratio (BER) requirement.

And mode selection probability Pr(Xₗ) is defined as the probability of selecting the l-th mode from the set of available transmission modes,

$$\begin{matrix}Pr ( {X}_{l} ) = Pr [ {μ}_{l - 1} \leq γ < {μ}_{l} ] \\ = {\int }_{{μ}_{l - 1}}^{{μ}_{t}} f ( γ ) ⅆ γ\end{matrix} \qquad [ Equation 11 ]$$

where f(γ) represents the probability density function (PDF) of γ.

By properly selecting the MIMO scheme, this scheme satisfies the diversity gain and very high-rate transmission according to the channel condition.

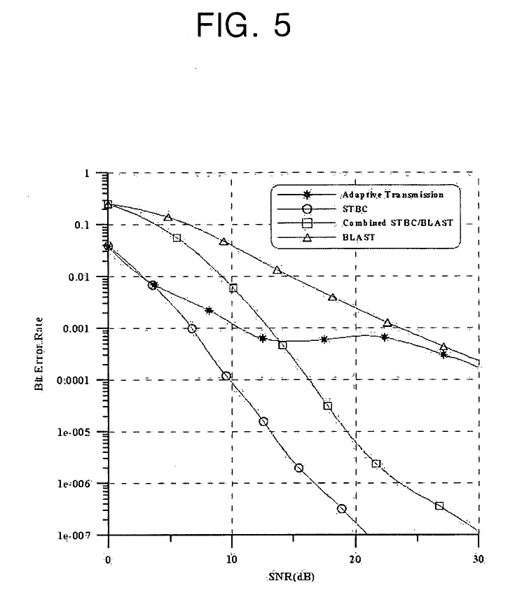

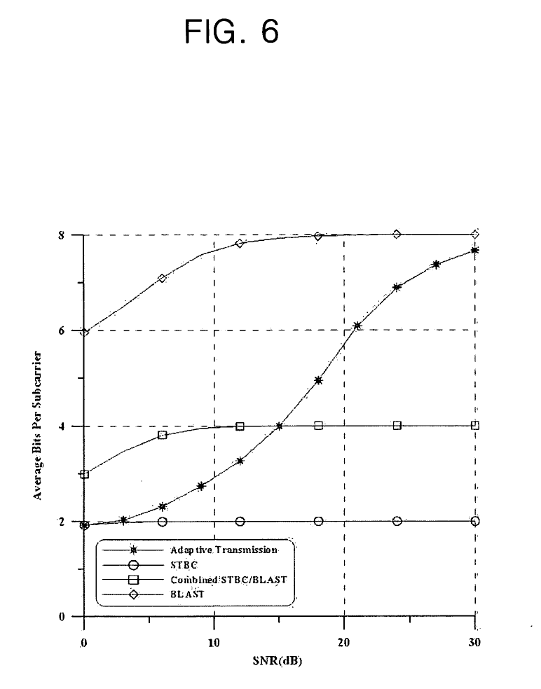

In FIG. 5 and FIG. 6, we show the BER and average BPS (bits per subcarrier) throughput performance of MIMO-OFDM system with the method of adaptive MIMO transmission with QPSK (quadrture phase shift keying) and Nₜ=Nᵣ=4. The performance of STBC, combined STBC/BLAST, and BLAST is also shown in these figures to compare with that of the method of adaptive transmission. Also, the values of SNR thresholds used to switch the transmission mode are μ₁=10 dB and μ₂=20 dB. From FIG. 6, we can see that the BPS performance of the adaptive method locates between that of STBC and that of BLAST. At SNR>20 dB, the adaptive method attains to a throughput of 8 BPS like a throughput performance of BLAST, but at SNR<10 dB, the throughput performance is still 2 BPS. In FIG. 5, at low SNR, the BER performance of adaptive method is dramatically improved by using the STBC, compared to that of the BLAST. Therefore, this adaptive method can satisfy the diversity gain and the high transmission rate.

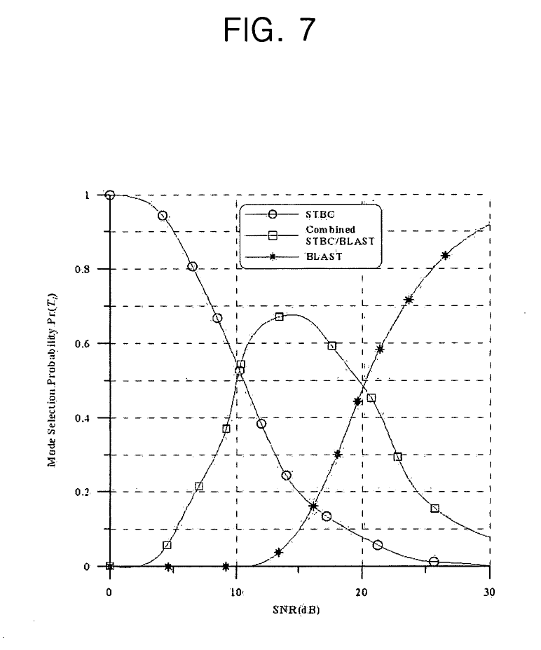

FIG. 7 shows the selection probability of transmission mode according to the SNR threshold. In this figure, we can see that the system mode transmitting to STBC scheme changes into the transmission mode of combined STBC/BLAST scheme at the neighborhood of the switching SNR threshold with an almost 50 percent probability of mode selection. In case of a low SNR, the probability which selects the transmission mode of BLAST is low, but at high SNR, SNR>20, the probability of BLAST is high. Therefore, the higher data rate or higher reliability can be achieved by changing the SNR thresholds.

While this invention has been described in connection with what is presently considered to be the most practical and preferred embodiment, it is to be understood that the invention is not limited to the disclosed embodiments, but, on the contrary, is intended to cover various modifications scope of the appended claims.

What is claimed is:

1. A method of estimating a SNR at a k-th subcarrier from an i-th transmitting antenna of a transmitter to a j-th receiving antenna of a receiver, the SNR given by:
$${SNR}_{ji}^{k} [ dB ] = 10 {log}_{10} \frac{{\vert {H}_{ji} ( k ) \vert}^{2} • {{S}_{i} ( k )}^{2}}{{ɛ}_{j}^{2}}$$
$$where$$
$${ɛ}_{j}^{2} = \frac{1}{K} {\sum }_{k = 0}^{K - 1} {( {R}_{j} ( k ) - {{\sum }_{l}}^{{N}_{r}} {H}_{ji} ( k ) {S}_{i} ( k ) )}^{2} .$$

2. The method of claim 1, wherein an average SNR value is calculated by estimating and averaging the SNR at all the receiving antennas using the following equation:
$${SNR}_{i}^{k} = \frac{1}{{N}_{r}} {\sum }_{j = 1}^{{N}_{r}} {SNR}_{ji}^{k} .$$

3. The method of claim 1, wherein an overall average SNR is calculated by averaging the average SNR over all subcarriers using the following equation:
$${SNR}_{i} = \frac{1}{K} {\sum }_{k = 0}^{K} {SNR}^{k} .$$

4. The method of claim 3, wherein the following MIMO transmission mode is decided by using the SNR:
$${T}_{l} = \{ \begin{matrix}STBC & if γ < {μ}_{1} \\ Combined & if {μ}_{1} \leq γ < {μ}_{2} \\ STBC / BLAST & \\ BLAST & if γ \geq {μ}_{2}\end{matrix}$$
where γ and μ₁ denote a channel quality value and a mode-switching level, respectively.

5. The method of claim 4, wherein the decided MIMO transmission mode is transmitted by using a feedback channel.

6. The method of claim 5, wherein the transmitter transmits information data by using the decided MIMO transmission mode according to mode-selecting feedback information received by the transmitter.

7. The method of claim 4, wherein the receiver demodulates received information data using a MIMO receiving mode according to the decided MIMO transmission mode.
